(19) United States
(12) Patent Application Publication
(10) Pub. No.: US 2021/0047201 A1
(43) Pub. Date: Feb. 18, 2021

(54) METHOD FOR PREPARING HIGH-VALENCE IRON SALT

(71) Applicant: Harbin Institute of Technology, Harbin City, Heilongjiang Province (CN)

(72) Inventors: Jun MA, Harbin (CN); Lu WANG, Harbin (CN); Yulei LIU, Harbin (CN)

(21) Appl. No.: 16/964,978

(22) PCT Filed: Mar. 12, 2018
(86) PCT No.: PCT/CN2018/078676

§ 371 Date: Jul. 25, 2020

(30) Foreign Application Priority Data
Jan. 26, 2018 (CN) 201810075803.1

(51) Int. Cl. C01G 49/00

(52) U.S. Cl. CPC C01G 49/0081

(57) ABSTRACT

A method for preparing high-valence iron salt; the present invention relates to a method for preparing a ferrate compound, for solving the technical problems of the complex operating process, the low yield, and the low purity of ferrate products after purification in existing methods for preparing potassium ferrate. The preparation method comprises: 1. weighing solid potassium hydroxide; 2. adding the solid potassium hydroxide to a sodium hypochlorite solution to obtain a hypochlorite solution; 3. adding iron salt to the hypochlorite solution to obtain a potassium ferrate solution; 4. adding the potassium ferrate solution to a cooled potassium hydroxide solution to obtain a solid-liquid mixture; 5. filtering the solid-liquid mixture of step 4; and 6. rinsing the solid-phase substance. The present invention has safe operation, is simple, quick, energy-saving, and easy to control, is suitable for immediate use, and the obtained product can be stored stably; the ferrate yield of the present method is 60-95% and the purity of the produced potassium ferrate solid is over 95%.

### BACKGROUND OF THE PRESENT INVENTION

### Field of Invention

The present invention relates to a preparation method of a ferrate (VI) compound.

### Description of Related Arts

Ferrate was discovered very early and found to be extremely oxidizing. It can be applied to different aspects such as bleaching and sterilization. Because ferrate is easily decomposed in water or wet conditions, it is difficult to prepare and store, so it has not been mass-produced and applied in any way. In 1702, German chemist and physicist Georg Stahl discovered potassium ferrate. In 1841, Fremy speculated about the existence of high-valent iron compounds. The synthesis of potassium ferrate in the laboratory began in 1987. From around 1940 until now, many scholars have studied the synthesis method of ferrate, and have proposed several methods for preparing ferrate, the purpose of which is based on the ability to synthesize a large amount of ferrate, and strive to make large-scale application possible. The basic synthesis principle of ferrate is to oxidize low-valent iron or elemental iron to high-valent iron under certain external reaction conditions.

To sum up the pre-existing preparation methods, the preparation method of potassium ferrate can be divided into three types, which are wet oxidation method, dry oxidation method, and electrolytic method.

The characteristics of the melting process are: The product is a mixture of various valence ferrate, which is easy to absorb moisture, unstable, and has low ferrate content, which is not suitable for preparing high-purity products. Although it can be mass-produced and the space-time efficiency of the equipment is high, the reaction temperature is high, and the presence or generation of caustic alkali causes serious corrosion of the reaction vessel. At the same time, the reaction is exothermic and the temperature increases quickly, which is easy to cause an explosion. The electrolysis method has lower requirements for raw materials and equipment, simple operation, less raw material consumption, and flexible and convenient operation. However, there are problems such as low product concentration, high production cost, low current efficiency, poor operation stability, high power consumption, and many by-products.

Wet oxidation is also called hypochlorite oxidation. In 1950, Hrostowski and Skott proposed a “two-step method”. First, iron salt and sodium hypochlorite were used as raw materials to react in alkaline solution to produce sodium ferrate, and then potassium hydroxide was added to produce potassium ferrate. Potassium ferrate precipitates due to its low solubility in high-concentration potassium hydroxide solution. Under alkaline conditions, especially strong alkaline conditions, iron salts are easiest to be oxidized to ferrate, because under strong alkaline environment, ferrate has the lowest oxidation-reduction potential and is easy to produce. The reaction equation is as follows:

2Fe³⁺+3ClO⁻+10OH⁻===2FeO₄²⁻+3Cl⁻+5H₂O (1)

The preparation method uses sodium hypochlorite to oxidize the ferric iron salt under alkaline conditions to generate sodium ferrate. A large amount of heat is released during the reaction, the ferrate yield is low, and most of the generated sodium ferrate exists in the reaction solution in a dissolved state, which is not easy to separate. In 1937, Schreyer proposed an improved method for preparing ferrate in the laboratory. The basic process is to use sodium hypochlorite or halogen gas (such as chlorine) to oxidize ferric iron salt in NaOH solution to generate sodium ferrate, and then add potassium hydroxide to convert sodium ferrate to potassium ferrate crystal precipitation. This method can precipitate most of the ferrate in the form of potassium ferrate, however, in the process of dissolving into potassium hydroxide, the generated ferrate will be partially decomposed, resulting in a decrease in yield. The precipitated product is a mixture of potassium ferrate, potassium salt, iron oxide, and potassium hydroxide. Due to the hygroscopic effect of potassium hydroxide, it is not easy to preserve and deliquescent. In the later period, Schreyer developed another method for preparing ferrate based on the above reaction. The main process is to introduce chlorine gas into the alkaline solution of ferric hydroxide to obtain potassium ferrate, and then purify it with an organic solvent.

Hypochlorite is easily decomposed by heat, and chlorine gas releases a large amount of heat into the alkaline solution to reduce the concentration of oxidant, which directly leads to low oxidation efficiency. The content of potassium ferrate in the product is only 10-15%. In order to improve the purity of the product, organic solvents such as benzene and ethanol are used to purify and cause part of potassium ferrate loss. Deininger proposed to introduce chlorine gas into the mixed solution of iron salt and potassium hydroxide to produce ferrate by the reaction of the intermediate product potassium hypochlorite and iron hydroxide. This method also has the problem of loss of oxidant. In addition, iron salt reacts with potassium hydroxide to easily generate iron hydroxide. This process also releases a lot of heat, which decomposes potassium hypochlorite. Wiliiams and Riley have made great improvements to this method, and proposed a “one-step method”, which is to introduce chlorine gas into potassium hydroxide solution to prepare a saturated potassium hypochlorite solution, and then use this solution to convert the ferric iron salt into ferrate. This method simplifies the purification step, the yield can reach more than 75%. However, this method has the following disadvantages: 1. The reaction process requires the preparation of chlorine gas, which increases the complexity of the process; 2. Chlorine gas will react with the generated hypochlorite (as shown in reaction equation 2), so that the effective chlorine concentration in the solution will be greatly reduced; 3. The hypochlorite solution produced by this method is unstable and will continue to produce potassium chloride crystals, which will increase the filtration resistance of purification, thereby affecting the yield and purity of ferrate.

ClO⁻+Cl₂+H₂O=Cl⁻+2HClO (2)

The above-mentioned wet process for preparing ferrate will generate excess heat or side reactions. As a result, there are too many impurities in the product and the output is low. Most of the preparation equipment uses titanium alloys, the investment is large and the cost is excessively high. This type of synthesis method is still difficult to adopt in practical applications.

### SUMMARY OF THE PRESENT INVENTION

In order to solve the technical problems of conventional preparation method of potassium ferrate, which includes complicated operation process, low yield rate and low purity of potassium ferrate product after purification, an object of the present invention is to provide a convenient and efficient method for preparing potassium ferrate.

According to the present invention, a preparation method of high-valent iron salt is realized according to the following steps:

(1) obtaining and weighing solid potassium hydroxide;

(2) adding the solid potassium hydroxide in the step (1) to sodium hypochlorite solution to form a reaction solution and control a temperature of the reaction solution at 0° C.˜20° C. to obtain a hypochlorite solution;

(3) adding iron salt to the hypochlorite solution obtained in the step (2) so that a molar ratio of hypochlorite to iron salt is 0.5˜8:1, then resulting a potassium ferrate solution;

(4) Cooling potassium hydroxide solution with a concentration of 10 mol/L 22 mol/L to a temperature of 0° C.˜10° C., adding the potassium ferrate solution in the step

(4) to the cooled potassium hydroxide solution and mixing uniformly to obtain a solid-liquid mixture;

(5) Filtering the solid-liquid mixture from the step 4 to collect a solid phase substance;

(6) Washing the solid phase substance collected from the step (5) to obtain a solid product of high-valent iron salt.

The present invention provides a preparation method of high-valent iron salt (potassium ferrate). First, in the preparation method of the present invention, the method of adding potassium hydroxide solid powder to the sodium hypochlorite solution is used to prepare the alkaline hypochlorite solution, which avoids the preparation of chlorine gas. The prepared alkaline hypochlorite solution has strong stability, and there is no problem of reactions between chlorine gas and hypochlorite, hypochlorite consumption, and chloride ions generation, and etc. Therefore, the oxidant concentration in the system is stabilized, and the yield and purity of potassium ferrate are improved. In addition, according to the present invention, the step of adding the produced potassium ferrate solution to the pre-cooled (0˜10° C.) high concentration potassium hydroxide can significantly weaken the self-decomposition process of potassium ferrate in the crystallization process of ferrate, and can improve the recovery rate and purity of potassium ferrate in the final product.

### Advantageous Effect of the Present Invention

### Advantageous Effect

According to the method of the present invention, the yield of ferrate can reach 60%˜95%, and the solid purity of potassium ferrate produced can reach more than 95%.

### Preferred Embodiment of the Present Invention

### DETAILED DESCRIPTION OF THE PREFERRED EMBODIMENT

### Embodiment 1

According to this embodiment of the present invention, the preparation method of high-valent iron salt comprises the following steps:

(1) weighing and obtaining solid potassium hydroxide;

(2) adding the solid potassium hydroxide in the step (1) to sodium hypochlorite solution to form a reaction solution and control a temperature of the reaction solution at 0° C. to 20° C. to obtain a hypochlorite solution;

(3) adding iron salt to the hypochlorite solution obtained in the step (2) so that a molar ratio of hypochlorite to iron salt is 0.5˜8:1, then resulting a potassium ferrate solution;

(4) Cooling potassium hydroxide solution with a concentration of 10 mol/L 22 mol/L to a temperature of 0° C.˜10° C., adding the potassium ferrate solution in the step (3) to the cooled potassium hydroxide solution and mixing uniformly to obtain a solid-liquid mixture;

(5) Filtering the solid-liquid mixture from the step 4 to collect a solid phase sub stance;

(6) Washing the solid phase substance collected from the step (5) to obtain a solid product of high-valent iron salt.

According to this embodiment, after carrying out the step (3) of adding iron salt to the hypochlorite solution for reaction for 10˜120 min, a potassium ferrate solution with a yield of 50%˜95% can be obtained.

According to this embodiment, the potassium hydroxide solution prepared in the step (4) is a saturated or supersaturated solution. That is, there are some undissolved potassium hydroxide solid particles at the bottom of the container (the mass of the undissolved potassium hydroxide solid particles accounts for 0%˜50% of the mass of the entire solution system).

### Embodiment 2

This embodiment is different from the embodiment 1 in that the solid potassium hydroxide in the step (1) is in the form of flake particles or powder.

### Embodiment 3

This embodiment is different from the embodiment 1 or 2 in that the effective concentration of chlorine in the sodium hypochlorite solution in the step (2) is 20˜150 g/L.

### Embodiment 4

This embodiment is different from one of the embodiments 1 to 3 in that the concentration of potassium hydroxide in the hypochlorite solution in the step (2) is 3˜15 mol/L.

### Embodiment 5

This embodiment is different from the embodiment 4 in that the concentration of potassium hydroxide in the hypochlorite solution in the step (2) is 7˜15 mol/L.

### Embodiment 6

This embodiment is different from one of the embodiments 1 to 5 in that: a temperature of the reaction solution is controlled at 0° C.˜60° C. and a reaction time is 10˜120 min for the step of adding iron salt to the hypochlorite solution for reaction in the step (3).

### Embodiment 7

This embodiment is different from the embodiment 6 in that: the temperature of the reaction solution is controlled at 5° C.˜40° C. and a reaction time is 30˜90 min for the step of adding iron salt to the hypochlorite solution for reaction in the step (3).

### Embodiment 8

This embodiment is different from one of the embodiments 1 to 7 in that: the molar ratio of hypochlorite to iron salt is 0.5˜5:1 in the step (3).

### Embodiment 9

This embodiment is different from the embodiment 8 in that: the molar ratio of hypochlorite to iron salt is 1˜4:1 in the step (3).

### Embodiment 10

This embodiment is different from one of the embodiments 1 to 9 in that: the iron salt in the step (3) is one or a mixture of two or more of the group consisting of: ferric chloride, ferrous chloride, ferric nitrate, ferrous nitrate, ferric sulfate and ferrous sulfate.

### Embodiment 11

This embodiment is different from one of the embodiments 1 to 10 in that: the potassium hydroxide solution is cooled to a temperature of 2° C.˜8° C. in the step (4).

### Embodiment 12

This embodiment is different from one of the embodiments 1 to 11 in that: a glass fiber membrane is used to filter the solid-liquid mixture.

### Embodiment 13

This embodiment is different from one of the embodiments 1 to 12 in that: the solid phase substance collected in the step (6) is washed sequentially with n-hexane, n-pentane, methanol, and ether.

### Exemplary Embodiment 1

According to this embodiment, the method of preparing high-valent iron salt comprises the following steps:

(1) obtaining and weighing potassium hydroxide in flake particle form;

(2) adding the potassium hydroxide in flake particle form in the step (1) to sodium hypochlorite solution to form a reaction solution and control a temperature of the reaction solution at 20° C. to obtain a strong alkaline hypochlorite solution, wherein a potassium hydroxide concentration in the final hypochlorite solution is 4 mol/L;

(3) adding ferric chloride to the hypochlorite solution obtained from the step (2) so that a molar ratio of hypochlorite to iron salt is 1.5:1, controlling a temperature of the reaction solution at 5° C., allowing reaction for 90 minutes and then a potassium ferrate solution in purple-black color with a yield of 65% is obtained;

(4) Cooling potassium hydroxide solution with a concentration of 10 mol/L to a temperature of 4° C., under a 4° C. condition (low temperature water bath to control the temperature of the reaction system), adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 85%.

### Exemplary Embodiment 2

According to this embodiment, the method of preparing high-valent iron salt comprises the following steps:

(1) obtaining and weighing potassium hydroxide in solid particle form, and crushing by using a pulverizer to form potassium hydroxide in powder form;

(2) adding the potassium hydroxide in powder form from the step (1) to sodium hypochlorite solution to form a reaction solution and control a temperature of the reaction solution at 10° C. to obtain a hypochlorite solution, wherein a potassium hydroxide concentration in the final hypochlorite solution is 6 mol/L;

(3) adding ferric chloride to the hypochlorite solution obtained from the step (2) so that a molar ratio of hypochlorite to iron salt is 2:1, controlling a temperature of the reaction solution at 10° C., allowing reaction for 75 minutes and then a potassium ferrate solution in purple-black color with a yield of 75% is obtained;

(4) Cooling potassium hydroxide solution with a concentration of 20 mol/L to a temperature of 5° C., under a 0° C. condition, adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 88%.

### Exemplary Embodiment 3

According to this embodiment, the method of preparing high-valent iron salt comprises the following steps:

(1) obtaining and weighing potassium hydroxide in solid particle form, and crushing by using a pulverizer to form potassium hydroxide in powder form;

(2) adding the potassium hydroxide in powder form from the step (1) to sodium hypochlorite solution to form a reaction solution and control a temperature of the reaction solution at 5° C. to obtain a hypochlorite solution, wherein a potassium hydroxide concentration in the final hypochlorite solution is 7 mol/L;

(3) adding ferric chloride to the hypochlorite solution obtained from the step (2) so that a molar ratio of hypochlorite to iron salt is 3:1, controlling a temperature of the reaction solution at 25° C., allowing reaction for 45 minutes and then a potassium ferrate solution in purple-black color with a yield of 85% is obtained;

(4) Cooling potassium hydroxide solution with a concentration of 15 mol/L to a temperature of 6° C., under a 2° C. condition, adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 90%.

### Exemplary Embodiment 4

According to this embodiment, the method of preparing high-valent iron salt comprises the following steps:

(1) obtaining and weighing potassium hydroxide in solid particle form, and crushing by using a pulverizer to form potassium hydroxide in powder form;

(2) adding the potassium hydroxide in powder form from the step (1) to sodium hypochlorite solution to form a reaction solution and control a temperature of the reaction solution at 5° C. to obtain a hypochlorite solution, wherein a potassium hydroxide concentration in the final hypochlorite solution is 8 mol/L;

(3) adding ferric chloride to the hypochlorite solution obtained from the step (2) so that a molar ratio of hypochlorite to iron salt is 4:1, controlling a temperature of the reaction solution at 35° C., allowing reaction for 30 minutes and then a potassium ferrate solution in purple-black color with a yield of 92% is obtained;

(4) Cooling potassium hydroxide solution with a concentration of 18 mol/L to a temperature of 8° C., under a 4° C. temperature condition, adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 93%.

### Exemplary embodiment 5

According to this embodiment, the method of preparing high-valent iron salt comprises the following steps:

(1) obtaining and weighing potassium hydroxide in solid particle form, and crushing by using a pulverizer to form potassium hydroxide in powder form;

(2) adding the potassium hydroxide in powder form from the step (1) to sodium hypochlorite solution to form a reaction solution and control a temperature of the reaction solution at 0° C. to obtain a hypochlorite solution, wherein a potassium hydroxide concentration in the final hypochlorite solution is 9 mol/L;

(3) adding ferric chloride to the hypochlorite solution obtained from the step (2) so that a molar ratio of hypochlorite to iron salt is 4:1, controlling a temperature of the reaction solution at 35° C., allowing reaction for 30 minutes and then a potassium ferrate solution in purple-black color with a yield of 95% is obtained;

(4) Cooling potassium hydroxide solution with a concentration of 22 mol/L to a temperature of 4° C., under a 4° C. temperature condition, adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 95%.

### Exemplary Embodiment 6

According to this embodiment, the method of preparing high-valent iron salt comprises the following steps:

(1) obtaining and weighing potassium hydroxide in solid particle form, and crushing by using a pulverizer to form potassium hydroxide in powder form;

(2) adding the potassium hydroxide in powder form from the step (1) to sodium hypochlorite solution to form a reaction solution and control a temperature of the reaction solution at 0° C. to obtain a hypochlorite solution, wherein a potassium hydroxide concentration in the final hypochlorite solution is 9 mol/L;

(3) adding ferric chloride to the hypochlorite solution obtained from the step (2) so that a molar ratio of hypochlorite to iron salt is 4:1, controlling a temperature of the reaction solution at 35° C., allowing reaction for 30 minutes and then a potassium ferrate solution in purple-black color with a yield of 95% is obtained;

(4) dissolving potassium hydroxide in solid particle form at a room temperature (10° C.-35° C.) to prepare a saturated potassium hydroxide solution, some of the potassium hydroxide in solid particle form are undissolved at a bottom of a container (a mass of the undissolved potassium hydroxide in solid particle form accounts for 50% of the entire solution system, cooling the fully saturated potassium hydroxide solution to a temperature of 4° C., under a 4° C. temperature condition, adding the potassium ferrate solution from the step (3) to the cooled potassium hydroxide solution and mixing uniformly such that ferrate is precipitated as potassium ferrate crystals to obtain a solid-liquid mixture;

(5) Filtering the solid-liquid mixture from the step 4 by using a glass fiber membrane with a pore size of 1.2 μm to collect a solid phase substance;

(6) Washing the solid phase substance collected from the step (5) sequentially with n-hexane, n-pentane, methanol, and ether to obtain a solid product of high-valent iron salt.

According to this embodiment, the purity of the potassium ferrate solid product obtained is 95%.

What is claimed is:

1. A method of preparing high-valent iron salt, characterized in that said method is realized by the following steps of:
(1) obtaining and weighing solid potassium hydroxide;
(2) adding the potassium hydroxide in solid form from the step (1) to sodium hypochlorite solution, during the process, controlling a temperature of the reaction solution at 0° C.-20° C. to obtain a hypochlorite solution;
(3) adding iron salt to the hypochlorite solution obtained in the step (2) so that a molar ratio of hypochlorite to iron salt is 0.5-8:1, then resulting a potassium ferrate solution;
(4) Cooling potassium hydroxide solution with a concentration of 10 mol/L 22 mol/L to a cooling temperature of 0° C.-10° C., then adding the potassium ferrate solution in the step (3) to the cooled potassium hydroxide solution and mixing uniformly to obtain a solid-liquid mixture;
(5) Filtering the solid-liquid mixture from the step 4 to collect a solid phase substance;
(6) Washing the solid phase substance collected from the step (5) to obtain a solid product of high-valent iron salt.

2. The method of preparing high-valent iron salt according to claim 1, characterized in that: in the step (1), the solid potassium hydroxide is in the form of flake particles or powder.

3. The method of preparing high-valent iron salt according to claim 2, characterized in that: in the step (2), an effective concentration of chlorine in the sodium hypochlorite solution is 20˜150 g/L.

4. The method of preparing high-valent iron salt according to claim 2, characterized in that: in the step (2), a concentration of potassium hydroxide in the hypochlorite solution is 3-15 mol/L.

5. The method of preparing high-valent iron salt according to claim 1, characterized in that: for adding iron salt to the hypochlorite solution in the step (3), a temperature of the reaction solution is controlled at 0° C.˜60° C. and a reaction time is 10˜120 min.

6. The method of preparing high-valent iron salt according to claim 1, characterized in that: in the step (3), the molar ratio of hypochlorite to iron salt is 0.5˜5:1.

7. The method of preparing high-valent iron salt according to claim 1, characterized in that: in the step (3), the iron salt is one or a mixture of two or more of the group consisting of: ferric chloride, ferrous chloride, ferric nitrate, ferrous nitrate, ferric sulfate and ferrous sulfate.

8. The method of preparing high-valent iron salt according to claim 1, characterized in that: in the step (4), the potassium hydroxide solution is cooled to a temperature of 2° C.˜8° C.

9. The method of preparing high-valent iron salt according to claim 1, characterized in that: in the step (5), the solid-liquid mixture is filtered by using a glass fiber membrane.

10. The method of preparing high-valent iron salt according to claim 1, characterized in that: in the step (6), the solid phase substance is washed sequentially with n-hexane, n-pentane, methanol, and ether.
